(19) United States
(12) Patent Application Publication
(10) Pub. No.: US 2020/0308438 A1
(43) Pub. Date: Oct. 1, 2020

(54) COATING COMPOSITIONS

(71) Applicant: Hewlett-Packard Development Company, L.P., Spring, TX (US)

(72) Inventors: Bor-Jiunn NIU, San Diego, CA (US); Tao CHEN, San Diego, CA (US); Or BRANDSTEIN, San Diego, CA (US)

(73) Assignee: Hewlett-Packard Development Company, L.P., Spring, TX (US)

(21) Appl. No.: 16/765,580

(22) PCT Filed: Jan. 17, 2018
(86) PCT No.: PCT/US2018/014009

§ 371 Date: May 20, 2020

(51) Int. Cl. C09D 129/04; C09D 179/08; B41M 5/00; B41M 5/52

(52) U.S. Cl. CPC C09D 129/04; C09D 179/08; C08K 3/105; B41M 5/5263; B41M 5/5218; B41M 5/0017

(57) ABSTRACT

The present disclosure is drawn to coating compositions. The coating composition can include from 60 wt % to 90 wt % water; from 5 wt % to 40 wt % polyethyleneimine; from 5 wt % to 40 wt % polyvinyl alcohol, polyethylene oxide-modified polyvinyl alcohol, or a mixture thereof; and from 0.5 wt % to 10 wt % cationic salt. The coating composition can have a viscosity ranging from 50 cps to 400 cps.

### BACKGROUND

Inkjet printing has become a popular way of recording images on various media. Some of the reasons include low printer noise, variable content recording, the capability of high-speed recording, and multi-color recording. These advantages can be obtained at a relatively low price to consumers. As the popularity of inkjet printing increases, the types of use also increase creating a demand for new materials.

### BRIEF DESCRIPTION OF DRAWINGS

Additional features and advantages of the disclosure will be apparent from the detailed description that follows, which taken in conjunction with the accompanying drawings illustrates, by way of examples, features of the present technology. It should be understood that the figures are representative of examples of the present disclosure and should not be considered as limiting the scope of the disclosure.

FIG. 1 schematically displays an example of a coated print medium in accordance with the present disclosure; and

FIG. 2 schematically displays an example method of printing in accordance with the present disclosure.

### DETAILED DESCRIPTION

Coated print media, such as for inkjet printing, can include water-soluble cationic polymeric binders the coating of the media. These polymers can improve image quality due to their affinity with ink compositions, such ink compositions with anionic component contained therein. However, with this type of solution implemented, often the coating found on the coated print media can lead to poor image gloss. Furthermore, with inkjet press printing, such as with an HP PageWide® (HP® Inc., California) web press printer for publishing applications, poor image gloss can be of concern as customers can be accustomed to higher color gloss with more traditional printing press technologies. Thus, in accordance with the present disclose, a coating composition, coated print medium, and a method of printing are provided that can be used with inkjet presses with acceptable color quality and color gloss sufficient to meet customary demands of publishing customers.

In accordance with this, the present disclosure relates generally to coating compositions. In one example, a coating composition can include from 60 wt % to 90 wt % water; from 5 wt % to 40 wt % polyethyleneimine; from 5 wt % to 40 wt % polyvinyl alcohol, polyethylene oxide-modified polyvinyl alcohol, or a mixture thereof; and from 0.5 wt % to 10 wt % cationic salt. The coating composition can have a viscosity from 50 cps to 400 cps. In one example, the coating composition can further include from 3 wt % to 30 wt % latex that can have a glass transition (Tg) from 80° C. to 140° C. In another example, the polyethyleneimine can be a water-soluble branched polyethyleneimine. In yet another example, the coating composition can include both the polyvinyl alcohol and the polyethylene oxide-modified polyvinyl alcohol. In a further example, the cationic salt can include a cation of calcium, aluminum, or aluminum, or a mixture thereof. The viscosity of the coating composition can alternatively be from 100 cps to 300 cps.

A coated print medium is also described herein. In one example, the coated print medium can include a print medium having a coating layer applied thereto. The coating layer can include from 20 wt % to 40 wt % polyethyleneimine; from 24 wt % to 60 wt % polyvinyl alcohol, polyethylene oxide-modified polyvinyl alcohol, or a mixture thereof; and from 0.5 wt % to 10 wt % cationic salt. In one example, the coating layer can further include from 10 wt % to 30 wt % latex having a glass transition (Tg) from 80° C. to 140° C. In another example, the polyethyleneimine can be a water-soluble branched polyethyleneimine. In yet another example, the coating layer can include both the polyvinyl alcohol and the polyethylene oxide-modified polyvinyl alcohol.

In another example, a method of printing can include applying a coating composition to a print medium at from 0.3 gsm to 2 gsm to form a coated print medium and printing a pigmented anionic ink composition on the coated print medium to form a printed image. The coating composition can have a viscosity from 50 cps to 400 cps, and can include from 60 wt % to 90 wt % water; from 5 wt % to 40 wt % polyethyleneimine; from 5 wt % to 40 wt % polyvinyl alcohol, polyethylene oxide-modified polyvinyl alcohol, or a mixture thereof; and from 0.5 wt % to 10 wt % cationic salt. In one example, the method can include both applying the coating composition and printing the pigmented anionic ink composition at an application speed of 200 feet per minute to 800 feet per minute. In another example of the method, the printed image can have an average color gloss at 75° greater than 70. In yet another example, the coating composition can further include from 3 wt % to 30 wt % latex that can have a glass transition temperature (Tg) from 80° C. to 140° C. In a further example, the ethyleneimine groups of the polyethyleneimine can interact with the pigmented anionic ink composition upon printing the pigmented anionic ink composition on the coated print medium.

Turning now to further details regarding the coating composition, the coated print medium, and the method of printing, it is noted that when discussing any of these examples, each can be considered applicable to the other examples, whether or not they are explicitly discussed in the context of that example. Thus, in discussing polyethyleneimine in a coating composition, such disclosure is also relevant to and directly supported in the context of the coated print media (or dry components therefrom), and/or the methods described herein, and vice versa.

The coating composition presented herein can be an aqueous composition. In one example, the water content of the coating composition can range from 60 wt % to 90 wt %. In yet other examples, the water content of the coating composition can range from 65 wt % to 85 wt % or 70 wt % to 80 wt %. In some examples, the weight percentage of the water refers to all sources of water in the composition. For example, the weight percentage can include not only the amount of pure water but also the amount of water found in solutions, such as polyvinyl alcohol. In addition to acting as the primary solvent for the dry components in the coating composition, water can be used to control the viscosity of the coating composition.

In one example, the polyethyleneimine within the coating composition can be present at from 5 wt % to 40 wt %. In other examples, the polyethyleneimine can be present at from 5 wt % to 25 wt %, from 5 wt % to 15 wt %, or at from 6 wt % to 10 wt %. The polyethyleneimine can be a cationic polyethyleneimine and in some examples can be a water soluble branched polyethyleneimine. The polyethyleneimine in the coating can interact with a pigmented anionic ink. Specifically, the ethyleneimine groups on the polyethyleneimine can interact with carboxylic or hydroxyl group in a pigmented anionic ink. In some examples, the binding interaction can be based on hydrogen bonding. More specifically, the interaction between the ethyleneimine groups and the pigmented anionic ink composition can contribute to the improved color gloss properties of a printed image when a coated print medium of the present disclosure is printed on with a pigmented anionic ink composition. In some examples, the coating composition can exclude other water-soluble cationic polymeric binders, such as polyamines, dicyandiamides, poly-diallyl-dimethyl-ammonium chlorides (polyDADMAC), and the like. Polyamine, dicyandiamide, poly-diallyl-dimethyl-ammonium chloride (polyDADMAC), etc., when utilized in a coating composition may not provide the same level of color gloss compared to the polyethyleneimine of the present disclosure.

The coating composition can also include from 5 wt % to 40 wt % of polyvinyl alcohol (PVA), polyethylene oxide-modified polyvinyl alcohol (PEO-modified PVA), or a combination thereof. In some examples, the PVA and/or the PEO-modified PVA can be present at from 5 wt % to 30 wt %, from 5 wt % to 20 wt %, or from 7 wt % to 15 wt %. These weight percentages refer to the collective or total amount of the PVA, PEO-modified PVA or the combination thereof. In some examples, the coating composition can include one of polyvinyl alcohol or polyethylene oxide-modified polyvinyl alcohol. In yet other examples, the coating composition can include both the polyvinyl alcohol and the polyethylene oxide-modified polyvinyl alcohol.

The PEO-modified PVA can be a polyvinyl alcohol with polyethylene oxide side chain groups (CH₂CH₂O)ₓH, where x is from 10 to 500. In one example, the PEO-modified PVA can also include acetyl-oxy groups (CH₃—C(═O)—O—). In this example, the PEO-modified PVA with the acetyl-oxy groups can be acquired commercially under the tradename Gohsenx™, e.g., WO-320R (Nippon Gohsei, USA). The inclusion of the PEO-modified PVA can provide additional hydrophilic moieties to the polyvinyl alcohol, which can have the benefit of better affinity with co-solvents used in the ink as part of a liquid ink vehicle.

The cationic salt in the coating composition can be present at from 0.5 wt % to 10 wt %. In other examples, the cationic salt can be present at from 0.5 wt % to 5 wt % or from 1 wt % to 3 wt %. The cationic salt can be selected to provide calcium, magnesium, or aluminum cations, such as for example calcium chloride, magnesium chloride, aluminum chloride, aluminum sulfate, magnesium sulfate, calcium propionate, calcium acetate, calcium nitrate, or a combination thereof. In one specific example, the cationic salt can be calcium chloride. By including the cationic salt in the coating composition, this component can contribute to ink flocculation upon printing, thereby reducing print bleed.

In some examples, the coating composition can further include a high glass transition (Tg) temperature latex. As used herein, “high Tg” refers to a latex having a glass transition temperature of 80° C. to 140° C. In other examples, the latex can have a glass transition temperature of 90° C. to 110° C., or from 100° C. to 140° C. In still other examples, the latex can be present at from 3 wt % to 30 wt %, from 5 wt % to 25 wt %, from 4 wt % to 12 wt %, or from 5 wt % to 10 wt %. The latex can be an acrylic polymer, a methacrylic polymer, or a copolymer thereof with one or more other types of polymeric units, e.g., styrene, methyl methacrylate, etc. In one example, the latex can be an acrylic emulsion polymer. The polymerization of the latex can be structured or random, and in one example, the latex can be generally anionic or dispersed by an anionic surfactant. An exemplary commercially available latex that can be used in the coating compositions presented herein is RayCryl® 30S, which is an acrylic emulsion polymer latex commercially available from Specialty Polymers, Inc., South Carolina.

In further examples, the coating composition can include other solid or liquid components. For example, the coating composition can further include wax. In some examples, the wax can be present at from 1 wt % to 10 wt % wax. In yet other examples, the coating composition can include from 1 wt % to 5 wt % or from 2 wt % to 4 wt % wax. In some examples, the wax can be in the form of a water-based wax emulsion. In one example, the wax can be a non-ionic wax, such as a solid type high-density polyethylene (HDPE) wax.

In yet another example, the coating composition can further include an additive such as a surfactant, a defoamer, or other liquid ingredients in addition to the water content used to carry the other components to a surface of the print medium. When present, the surfactant can be present at from 0.01 wt % to 3 wt % or from 0.1 wt % to 2 wt % in the coating composition. In some examples, the surfactant can be a non-ionic and/or silicon-free surfactant. When present, the defoamer can be present at from 0.01 wt % to 3 wt % or from 0.05 wt % to 1 wt % of the coating composition.

The coating composition can have a viscosity be suitable for high-speed application. As used herein, “high-speed application” refers to application occurring at a speed of 200 feet per minute or more, e.g., from 200 feet per minute to 800 feet per minute. The coating composition can be applied by any analog or digital process either prior to loading into a printer or can be applied in-line within the printer at from 200 feet per minute or more. However, particularly for analog application, e.g., anilox roller, knife, curtain, mayer rod, etc., or a combination thereof, viscosities can range from 50 cps to 400 cps, from 100 cps to 300 cps, or from 250 cps to 350 cps can be suitable for high-speed application.

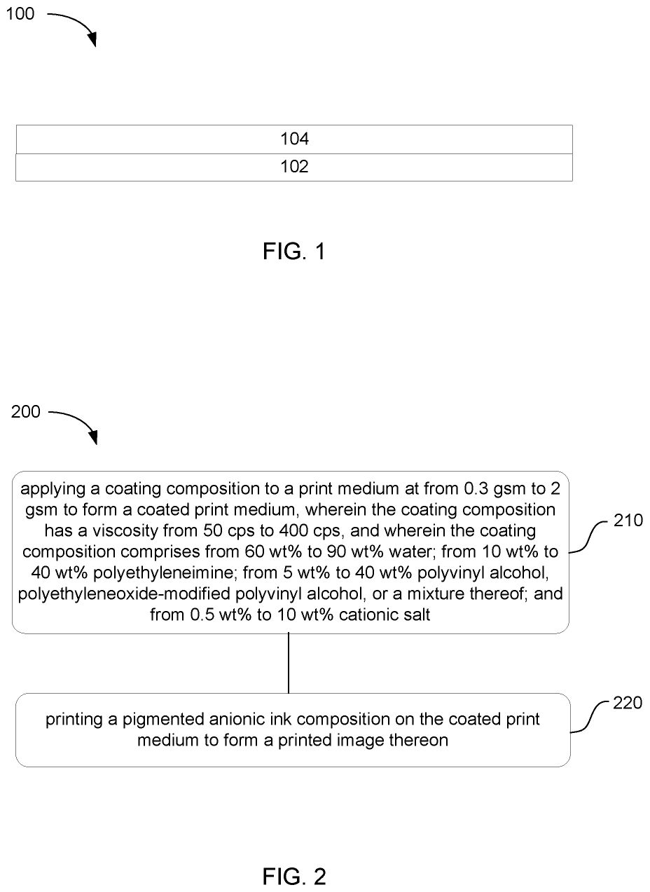

Turning now to the coated print medium 100, shown in FIG. 1. The coated print medium can include a print medium 102 with a coating composition 104 applied thereto. In some examples, the print medium can be a paper substrate. In some examples, the paper substrate can be a coated or an uncoated paper substrate. The coating composition can be applied to one or both sides of the print medium. Following application of a coating composition, the liquid components in the coating composition can evaporate therefrom leaving a dried coating on a surface of the print medium. Accordingly, the weight percentage of the dry components in the coating composition of the coated print medium can be greater than the weight percentages of these components in the aqueous coating composition prior to coating, e.g., after removal of water content from the coating composition.

In one example, the coating composition on the coated print medium can include from 20 wt % to 40 wt % polyethyleneimine; from 24 wt % to 60 wt % polyvinyl alcohol, polyethylene oxide-modified polyvinyl alcohol, or a mixture thereof; and from 0.5 wt % to 10 wt % cationic salt. In yet other examples, the coating composition on the coated print medium can include from 25 wt % to 35 wt % polyethyleneimine, from 20 wt % to 30 wt % polyethyleneimine, or from 30 wt % to 40 wt % polyethyleneimine. In another example, the coating composition on the coated print medium can include from 30 wt % to 55 wt % polyvinyl alcohol, polyethylene oxide-modified polyvinyl alcohol, or a mixture thereof. In a further detail, the coating on the coated print medium can include and from 4 wt % to 8 wt % cationic salt, or from 5 wt % to 10 wt % of a cationic salt. In yet other examples, the coating composition can further include from 10 wt % to 30 wt % or from 15 wt % to 25 wt % latex. Each of the components of the coating composition on the coated print medium can be as previously described.

In another example, a method of printing 200, as shown in FIG. 2, can include applying 210 a coating composition to a print medium at from 0.3 gsm to 2 gsm to form a coated print medium and printing 220 a pigmented anionic ink composition on the coated print medium to form a printed image. The coating composition can include from 60 wt % to 90 wt % water; from 5 wt % to 40 wt % polyethyleneimine; from 5 wt % to 40 wt % polyvinyl alcohol, polyethylene oxide-modified polyvinyl alcohol, or a mixture thereof; and from 0.5 wt % to 10 wt % cationic salt. The coating composition can have a viscosity from 50 cps to 400 cps, for example. In one example, the coating composition can further include from 3 wt % to 30 wt % latex that can have a glass transition (Tg) from 80° C. to 140° C. In other examples, the coating composition can be applied using a roller process, a floating knife process, knife on roll process, transfer coating process, dip coating process, a curtain coating process, anilox coating process, or a combination thereof. In some examples, the coating composition can be applied a dry coat weight ranging from 0.5 gsm to 1.5 gsm. The coating composition on the coated print medium can have a thickness ranging from 0.2 μm to 3 μm or from 0.3 μm to 2 μm.

In one example, both applying the coating composition and printing the pigmented anionic ink composition can occur separately, or from a common printer or press system. For example, the coating composition can be applied by any analog or digital process either prior to loading into a printer or can be applied in-line within the printer at from 200 feet per minute or more. In other examples, the application speed can vary from 400 feet per minute to 800 feet per minute, from 200 feet per minute to 600 feet per minute, or from 300 feet per minute to 700 feet per minute.

Following printing, the printed image can exhibit acceptable average color gloss. In one example, the printed image can have an average color gloss at 75° of greater than 70, greater than 75, greater than 80, or even greater than 85. “Average color gloss” can be determined using six colors and black, (namely a black ink, a cyan ink, a magenta ink, and a yellow ink, and generating red, green, and blue by mixing cyan ink, magenta ink, and/or yellow ink) each ink printed at 1-2 drop weight of 4-6 ng per pixel. In another example, the printed image can have an average color gloss at 75° of greater than 70, greater than 75, or greater than even 80. “Average color gloss,” can be determined from cyan, magenta, yellow, red, blue, green, and black. “Minimum color gloss,” which is the color gloss from anionic pigmented ink composition with the lowest value from the group (all colors and black) can be greater than 65 or greater than 70, for example (measured the same way, but without taking an average across colors). The color gloss benefits of the printed images can be improved generally due to an interaction between the polyethyleneimine and the pigmented anionic ink composition. In one example, ethyleneimine groups of the polyethyleneimine can interact with the pigmented anionic ink composition upon printing the pigmented anionic ink composition on the coated print medium. These color gloss benefits can be obtained while still obtaining good image quality of the printed image, provided in part by some of the other components that may also be present in the coating composition or coated layer of the coated print medium.

It is noted that, as used in this specification and the appended claims, the singular forms “a,” “an,” and “the” include plural referents unless the content clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of 1 wt % to 20 wt % should be interpreted to include not only the explicitly recited limits of 1 wt % and 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following illustrates several examples of the present disclosure. However, it is to be understood that the following is only illustrative of the application of the principles of the present disclosure. Numerous modifications and alternative compositions, methods, and systems may be devised without departing from the spirit and scope of the present disclosure. The appended claims are intended to cover such modifications and arrangements.

### Example 1—Coating Compositions and Coated Print Media Samples

Five different coating compositions and coated print media samples were prepared. In order to prepare the coating compositions, the dry components were mixed together with about 75 wt % water to 25 wt % dry components, according to the weight percentages shown in Table 1 below. The various coating compositions were applied to an offset coated paper medium at 1.5 gsm utilizing a Mayer rod to form the coated print media samples.

TABLE 1
Dry Components Weight Percentage

| Component | Type | Ex. 1 | Ex. 2 | Ex. 3 | Ex. 4 | Ex. 5 |
|---|---|---|---|---|---|---|
| ¹Raycryl ® 30S | Anionic latex | 20 | 0 | 20 | 20 | 20 |
| ²Gohsenx ™ | Polyethylene oxide- | 24 | 40 | 24 | 24 | 24 |
| WO-320R | modified PVA | | | | | |
| ³Mowiol ® 4-88 | PVA | 5 | 0 | 5 | 5 | 5 |
| ³Mowiol ® 13-88 | PVA | 5 | 14 | 5 | 5 | 5 |
| ⁴Lupasol ® PS | Polyethyleneimine | 30 | 30 | 0 | 0 | 0 |
| ⁵Floquat ™ Dec | Dicyandiamide | 0 | 0 | 30 | 0 | 0 |
| 50 | | | | | | |
| ⁵Floquat ™ 2250 | Polyamine | 0 | 0 | 0 | 30 | 0 |
| ⁵Floquat ™ 4440 | Poly-diallyl-dimethyl | 0 | 0 | 0 | 0 | 30 |
| | ammonium chloride | | | | | |
| | (polyDADMAC) | | | | | |
| ⁶Ultralube ® 846 | Polyethylene wax | 10 | 10 | 10 | 10 | 10 |
| ⁶Tego ® wet 510 | Non-ionic Silicon | 0.8 | 0.8 | 0.8 | 0.8 | 0.8 |
| | Free Surfactant | | | | | |
| ⁷BYK 018 | Defoamer | 0.7 | 0.7 | 0.7 | 0.7 | 0.7 |
| CaCl₂ | Calcium salt | 4.5 | 4.5 | 4.5 | 4.5 | 4.5 |

¹RayCryl ® is available from Specialty Polymers, Inc., USA.
²Gohsenx ™ is available from Nippon Gohsei, USA.
³Mowiol ® is available from Sigma-Aldrich ® Corp., USA.
⁴Lupasol ® PS is available from BASF, Germany.
⁵Floquat ™ is available from SNF Floeger, France.
⁶Ultralube ® and Tego ® are available from GmbH, Germany.
⁷BYK is available from BYK USA, Inc., USA.

### Example 2—Analysis of a Printed Image on the Coated Print Media Samples

Following the preparation of the coated print media samples of Example 1, the various coated print media samples were tested for sheet gloss at 75°. In order to determine sheet gloss, a beam of light was projected onto the coated surface of the coated print media samples at an angle of 75° from vertical and the reflectance was detected and measured by a gloss meter available from BYK.

Following the sheet gloss measurement, an inkjet image was printed on each of the coated print media samples at 4 ng drop weight per pixel using HP A50 ink, which is a pigmented anionic ink. The ink was printed on the coated print media samples using an HP PageWide® Press (HP® Inc., California) at a print speed of 200 feet per minute.

The image quality and color gloss from four different inks were tested, namely black ink, cyan ink, magenta ink, and yellow ink. Images were also printed in red, green, and blue which were generated by mixing cyan ink, magenta ink, and/or yellow ink. The color gloss was measured for all the colors (cyan, magenta, yellow, red, green, and blue) and black using the same methodology described above for determining sheet gloss. In order to determine average color gloss, the color gloss for the various colors and black were printed and measured, and then an average value of all the colors and black was statistically obtained. Minimum color gloss values indicate the lowest color gloss value measured from all of the tested colors and black of a given group, e.g., cyan, magenta, yellow, red, blue, green, and black. In further detail, to test for image quality, the overall IQ ranking was used to evaluate ink bleeding and blue color coalescence, etc.

The results for sheet gloss, average color gloss (all the colors (cyan, magenta, yellow, red, green, and blue) and black), minimum color gloss (lowest value from all the colors (cyan, magenta, yellow, red, green, and blue) and black), is shown in Table 2. Also shown in Table 2 is the overall image quality ranking for all of the inks on the various coated print media samples.

TABLE 2
Print Quality Testing

| Print Quality Feature | Ex. 1 | Ex. 2 | Ex. 3 | Ex. 4 | Ex. 5 |
|---|---|---|---|---|---|
| Sheet gloss at 75° before printing | 90 | 88 | 46 | 66 | 14 |
| Average color gloss at 75° | 88 | 79 | 35 | 46 | 13 |
| Minimum color gloss at 75° | 82 | 76 | 30 | 38 | 10 |
| Average IQ ranking | 4 | 4 | 5 | 5 | 5 |

Examples 1 and 2 incorporated polyethyleneimine as a water-soluble cationic polymer in the coating composition while Examples 3, 4, 5 and incorporated different water-soluble cationic polymers (dicyandiamide, polyamine, and polyDADMAC, respectively) in the coating composition. The sheet gloss, average color gloss values, and minimum color gloss at 75° values were highest for Example 1 and lowest for Example 5. Examples 1 and 2, which included polyethyleneimine, exhibited substantially better sheet gloss and color gloss than Examples 3-5. In general the primary colors (cyan, magenta, and yellow) performed better than the secondary colors (red, blue, and green). The minimum color gloss values for the primary colors at 75° exceeded 70 in Examples 1 and 2. An acceptable criterion for average sheet gloss and/or an average color gloss values at 75° of greater than 70 can be considered good and greater than 75 can be considered very good. Furthermore, a minimum average color gloss value at 75° greater than 65 or 70 may also be considered good, depending in some instances, and greater than 75 excellent.

With respect to the image quality, all of the example print media performed well. A good image quality rating may be considered to be any value 3 or more, with 4 being very good and 5 being excellent. While Examples 3-5 performed slightly better with respect to image quality, these examples performed poorly with respect to color gloss. Examples 1 and 2 only performed slightly worse in the area of bleed and color hold than Examples 3-5, which is why these examples obtained a slightly lower score. Examples 1 and 2, however, still exhibited very good image quality overall while being significantly better with respect to color gloss. Accordingly, Examples 1 and 2 which incorporated polyethyleneimine in the coating composition performed well in the areas of color gloss and image quality, whereas Examples 3-5, which included other water-soluble cationic polymers in the coating composition, did not exhibit good color gloss.

What is claimed is:

1. A coating composition, comprising:
from 60 wt % to 90 wt % water;
from 5 wt % to 40 wt % polyethyleneimine;
from 5 wt % to 40 wt % polyvinyl alcohol, polyethylene oxide-modified polyvinyl alcohol, or a mixture thereof; and
from 0.5 wt % to 10 wt % cationic salt,
wherein the coating composition has a viscosity from 50 cps to 400 cps.

2. The coating composition of claim 1, further comprising from 3 wt % to 30 wt % latex having a glass transition temperature (Tg) from 80° C. to 140° C.

3. The coating composition of claim 1, wherein the polyethyleneimine is a water-soluble branched polyethyleneimine.

4. The coating composition of claim 1, wherein the coating composition includes both the polyvinyl alcohol and the polyethylene oxide-modified polyvinyl alcohol.

5. The coating composition of claim 1, wherein the cationic salt comprises a cation of calcium, magnesium, aluminum, or a combination thereof.

6. The coating composition of claim 1, wherein the viscosity is from 100 cps to 300 cps.

7. A coated print medium, comprising a print medium including a coating applied thereto, wherein the coating layer includes:
from 20 wt % to 40 wt % polyethyleneimine;
from 24 wt % to 60 wt % polyvinyl alcohol, polyethylene oxide-modified polyvinyl alcohol, or a mixture thereof; and
from 0.5 wt % to 10 wt % cationic salt.

8. The print medium of claim 7, wherein the coating further comprises from 10 wt % to 30 wt % latex having a glass transition temperature (Tg) from 80° C. to 140° C.

9. The print medium of claim 7, wherein the polyethyleneimine is a water-soluble branched polyethyleneimine.

10. The print medium of claim 7, wherein the coating layer includes both the polyvinyl alcohol and the polyethylene oxide-modified polyvinyl alcohol.

11. A method of printing, comprising:
applying a coating composition to a print medium at from 0.3 gsm to 2 gsm to form a coated print medium, wherein the coating composition has a viscosity from 50 cps to 400 cps, and wherein the coating composition comprises:
from 60 wt % to 90 wt % water; from 5 wt % to 40 wt % polyethyleneimine,
from 5 wt % to 40 wt % polyvinyl alcohol, polyethylene oxide-modified polyvinyl alcohol, or a mixture thereof, and
from 0.5 wt % to 10 wt % cationic salt; and
printing a pigmented anionic ink composition on the coated print medium to form a printed image.

12. The method of claim 11, wherein both applying the coating composition and printing the pigmented anionic ink composition occurs at an application speed of 200 feet per minute to 800 feet per minute.

13. The method of claim 11, wherein the printed image has an average color gloss at 75° greater than 70.

14. The method of claim 11, wherein the coating composition further comprises from 3 wt % to 30 wt % latex having a glass transition temperature (Tg) from 80° C. to 140° C.

15. The method of claim 11, wherein ethyleneimine groups of the polyethyleneimine interact with the pigmented anionic ink composition upon printing the pigmented anionic ink composition on the coated print medium.
